(19) United States
(12) Patent Application Publication
(10) Pub. No.: US 2010/0135715 A1
(43) Pub. Date: Jun. 3, 2010

(54) FOLDING DEVICE WITH SAFE RETAINER

(76) Inventor: Bill Huang, Yuanlin Town (TW)

Correspondence Address: Bill Huang, No. 424, Ta Chee Road, Taichung, 401, omitted

(21) Appl. No.: 12/626,903

(22) Filed: Nov. 29, 2009

(30) Foreign Application Priority Data
Nov. 28, 2008 (TW) 097221332

(51) Int. Cl. F16B 7/00

(52) U.S. Cl. 403/83

(57) ABSTRACT

A folding device with a safe retainer comprises a base and a seat axially connected with each other, and a quick release assembly axially coupled to the connected base and seat, wherein the base includes a hole disposed on one side thereof and a tab mounted on another side thereof, and the seat includes a first connecting sleeve to correspond to the hole and a second connecting sleeve to correspond to the tab; the quick release assembly includes an engaging member and an adjusting shaft member axially connected with each other, and the engaging member includes a bore disposed on a lower end thereof to insert a first stem, and the adjusting shaft member includes a coupling segment formed on a lower side thereof to be pivoted to the tab of the base by using a second stem.

### BACKGROUND OF THE INVENTION

1. Field of the Invention

The present invention relates to a folding device with a safe retainer which is capable of positioning the head tube of the bicycle frame securely and safety.

2. Description of the Prior Art

Conventional a folding device is fixed to the head tube of the bicycle frame to fold bicycle easily. For example, a folding device of a bicycle as disclosed in TW Publication Nos. 132677, 249400, and 554877 includes quick release members disposed to a coupling end of a base or includes two supports fixed on two bases respectively, however such folding devices are not provided with a safety retainer to prevent the supports from release, causing danger.

The present invention has arisen to mitigate and or obviate the afore-described disadvantages.

### SUMMARY OF THE INVENTION

The primary object of the present invention is to provide a folding device with a safe retainer which is capable of positioning the head tube of the bicycle frame securely and safety.

To obtain the above objective, a folding device with a safe retainer provided by the present invention comprises:

a base and a seat axially connected with each other, and a quick release assembly axially coupled to the connected base and seat;

the base including a hole disposed on one side thereof and a tab mounted on another side thereof, and the seat including a first connecting sleeve fixed on one side thereof to correspond to the hole and a second connecting sleeve secured on another side thereof to correspond to the tab;

the quick release assembly including an engaging member and an adjusting shaft member axially connected with each other, and the engaging member including a bore disposed on a lower end thereof to insert a first stem, and the adjusting shaft member including a coupling segment formed on a lower side thereof to be pivoted to the tab of the base by using a second stem; wherein

between one end of the adjusting shaft and the second stem is defined a pillar, and the engaging member includes a positioning peg disposed thereon to engage the pillar, and the positioning peg includes a button fitted thereon so that the pillar moves in the positioning peg.

### BRIEF DESCRIPTION OF THE DRAWINGS

FIG. 1 is a perspective view showing the assembly of a folding device with a safe retainer in accordance with a preferred embodiment of the present invention;

FIG. 2 is a perspective view showing the exploded components of the folding device with the safe retainer in accordance with the preferred embodiment of the present invention;

FIG. 3 is across sectional view showing a part of the assembly and the operation of the folding device with the safe retainer in accordance with the preferred embodiment of the present invention;

FIG. 4 is a perspective view showing a part of the assembly and the operation of the folding device with the safe retainer in accordance with the preferred embodiment of the present invention;

FIG. 5 is a perspective view showing the operation of the folding device with the safe retainer in accordance with the preferred embodiment of the present invention;

FIG. 6 is another perspective view showing the operation of the folding device with the safe retainer in accordance with the preferred embodiment of the present invention;

FIG. 7 is a perspective view showing the folding device with the safe retainer being assembled to the head tube of the bicycle frame.

### DETAILED DESCRIPTION OF THE PREFERRED EMBODIMENTS

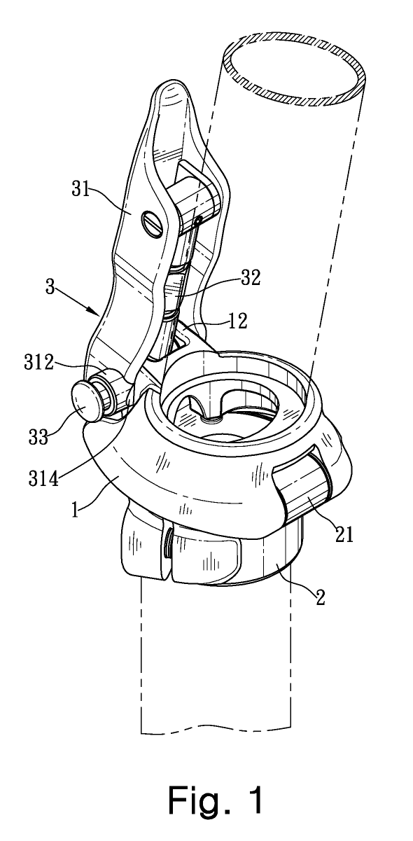

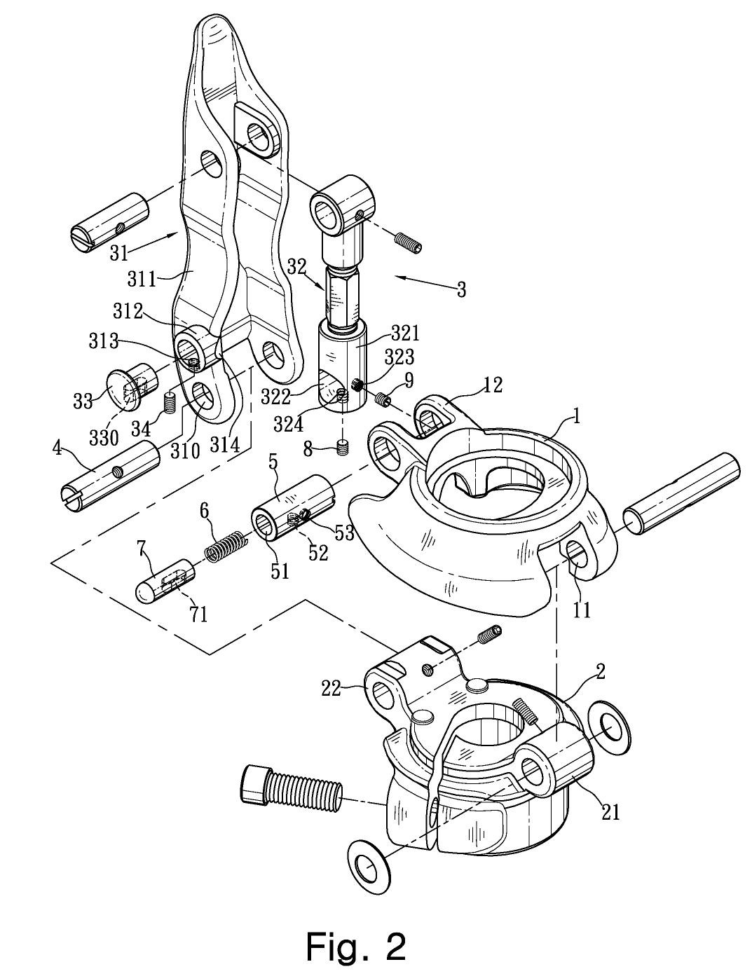

Referring to FIGS. 1 and 2, a folding device with a safe retainer according to a preferred embodiment of the present invention comprises a base 1 and a seat 2 disposed on a folding portion of a head tube of a bicycle frame to be axially connected with each other, and a quick release assembly 3 axially coupled to the connected base 1 and seat 2, wherein

the base 1 includes a hole 11 disposed on one side thereof and a tab 12 mounted on another side thereof, and the seat 2 includes a first connecting sleeve 21 fixed on one side thereof to correspond to the hole 11 and a second connecting sleeve 22 secured on another side thereof to correspond to the tab 12;

the quick release assembly 3 includes an engaging member 31 and an adjusting shaft member 32 axially connected with each other, and the engaging member 31 includes a bore 310 disposed on a lower end thereof to insert a first stem so that the engaging member 31 is axially fixed to the second connecting sleeve 22 of the seat 2, and the adjusting shaft member 32 includes a coupling segment 321 formed on a lower side thereof to be pivoted to the tab 12 of the base 1 by using a second stem 5; wherein

the adjusting shaft member 32 of the quick release assembly 3 and the second stem 5 are hollow and have a closed end respectively, and the second stem 5 includes a groove 51 arranged therein to receive a compression spring 6 and a pillar 7, the pillar 7 includes an arcuate end portion extending out of the second stem 5, and an indention 71 arranged therein, the second stem 5 includes a third aperture 52 radially disposed in the groove 51 so that a second screw 8 allows to be positioned to the indention 71 of the pillar 7 through the groove 51, and the pillar 7 is limited by the indention 71 and a second screw 8 to move in the second stem 5, and the second stem 5 is fixed to the coupling segment 321 of the adjusting shaft member 32, and the coupling segment 321 includes a radial opening 322 to receive the second stem 5, and the opening 322 includes an orifice 323 mounted on one side thereof to receive a third screw 9, and the third screw 9 is positioned to an outlet 53 which is formed on the second stem 5 to align with the pillar 7, and the opening 322 includes a second aperture 324 fixed on an outer end surface thereof to screw with a second screw 8, and the engaging member 31 includes a positioning peg 312 disposed thereon to engage the pillar 7, and the positioning peg 312 includes a T-shaped button 33 fitted thereon, the button 33 includes a slot 330 formed therein, the positioning peg 312 includes a first aperture 313 radially fixed therein in response to the positioning peg 312 so that a first screw 34 is locked to the slot 330 of the button 33 through the first aperture 313, hence the button 33 is limited by the slot 330 and the first screw 34 to move in the positioning peg 312, and a connection of the elongated side 311 of the engaging member 31 and the positioning peg 312 is provided with a beveled surface 314.

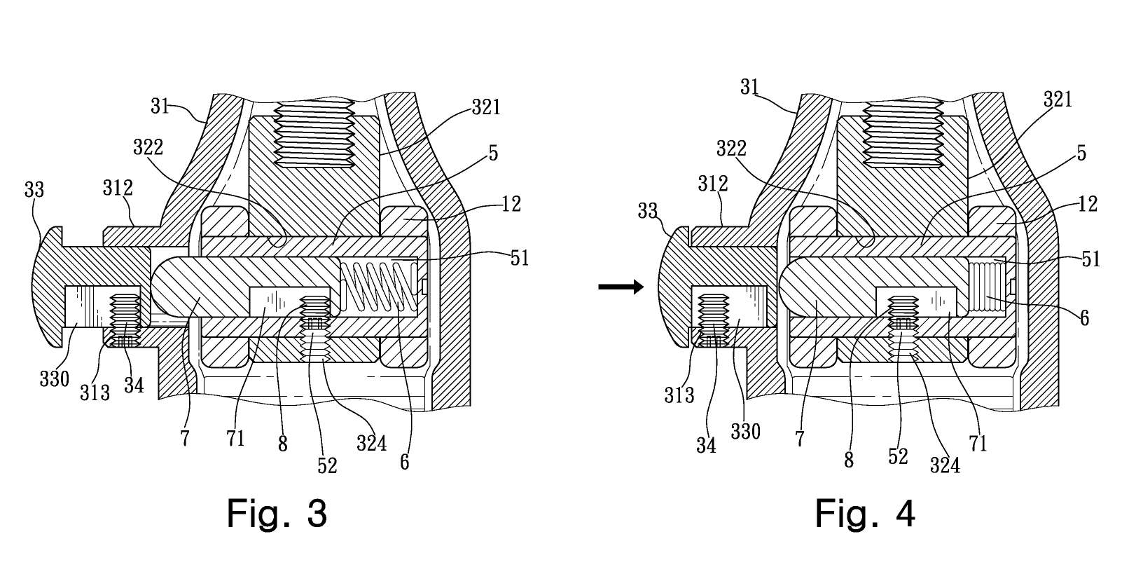

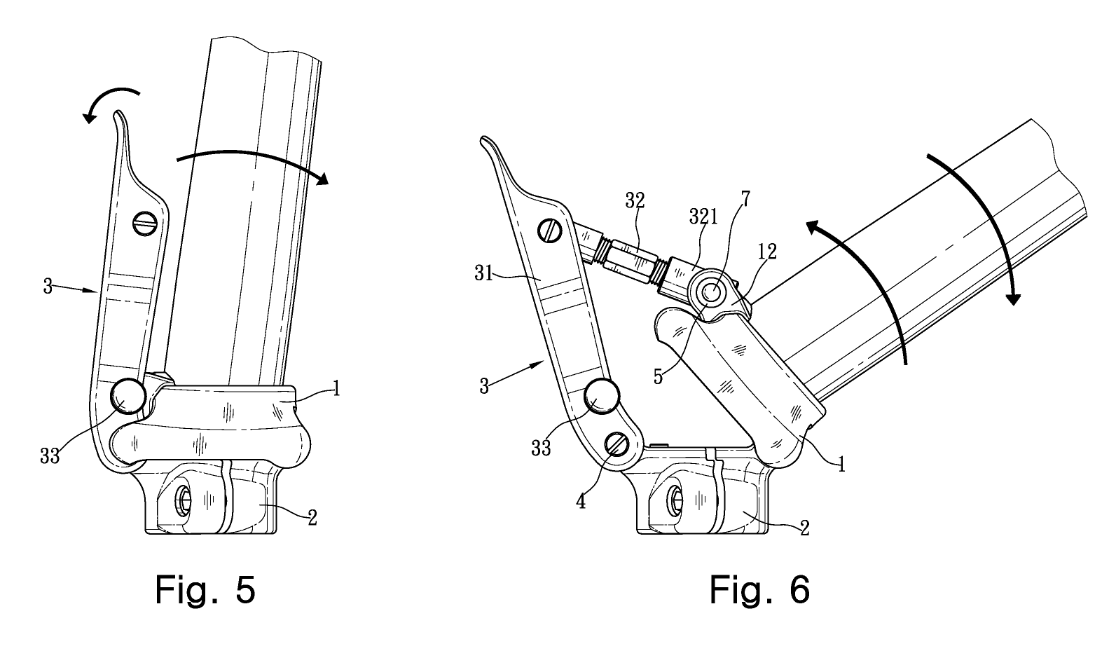

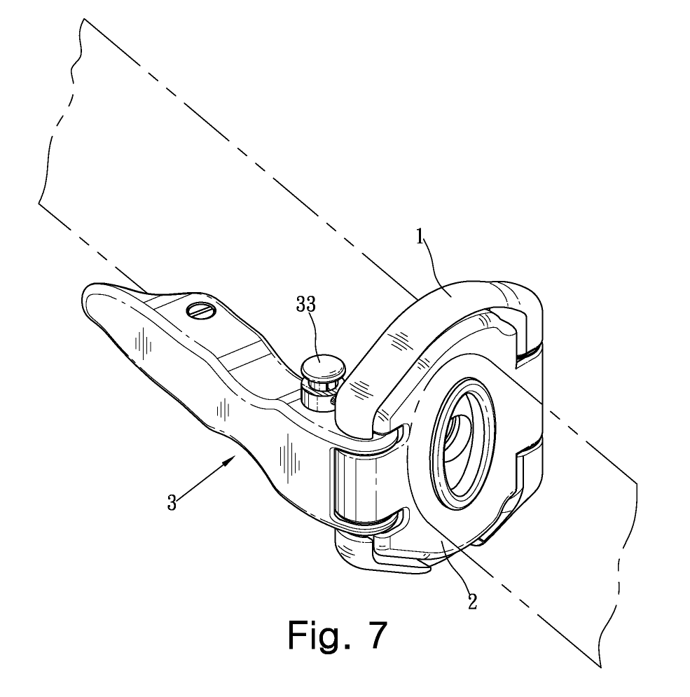

As shown in FIG. 3, In operation, the base 1 and the seat 2 are axially connected with the quick release assembly 3, and then the adjusting shaft member 32 of the quick release assembly 3 is retracted in the engaging member 31 to engage with the base 1, the positioning peg 312 is in response to the pillar 7, when the base 1 and the seat 2 are folded, the arcuate end portion of the pillar 7 contacts with the elongated side 311 of the engaging member 31 and the beveled surface 314, and the pillar 7 is pulled by the compression spring 6 to returns backward to the positioning peg 312, and when the pillar 7 is in alignment with the positioning peg 312, the pillar 7 is pushed by the compression spring 6 to move toward the positioning peg 312 to interfere the engaging member 31, the button 33 is pushed to move outward. In the meantime, the engaging member 31 is limited by the pillar 7 and the positioning peg 312, obtaining the safety of the quick release assembly 3. Besides, when a user is desired to folded the folding device, the button 33 is pressed so that the pillar 7 moves inward (as illustrated in FIG. 4) to release the pillar 7 and the positioning peg 312, thus moving the quick release assembly 3 outward to be folded (as shown in FIGS. 5 and 6).

While we have shown and described various embodiments in accordance with the present invention, it is clear to those skilled in the art that further embodiments may be made without departing from the scope of the present invention.

What is claimed is:

1. A folding device with a safe retainer comprising
a base and a seat axially connected with each other, and a quick release assembly axially coupled to the connected base and seat;
the base including a hole disposed on one side thereof and a tab mounted on another side thereof, and the seat including a first connecting sleeve fixed on one side thereof to correspond to the hole and a second connecting sleeve secured on another side thereof to correspond to the tab;
the quick release assembly including an engaging member and an adjusting shaft member axially connected with each other, and the engaging member including a bore disposed on a lower end thereof to insert a first stem, and the adjusting shaft member including a coupling segment formed on a lower side thereof to be pivoted to the tab of the base by using a second stem; wherein
between one end of the adjusting shaft and the second stem is defined a pillar, and the engaging member includes a positioning peg disposed thereon to engage the pillar, and the positioning peg includes a button fitted thereon so that the pillar moves in the positioning peg.

2. The folding device with a safe retainer as claimed in claim 1, wherein the adjusting shaft member of the quick release assembly and the second stem 5 are hollow and have a closed end respectively, and the second stem includes a groove arranged therein to receive a compression spring and a pillar.

3. The folding device with a safe retainer as claimed in claim 1, wherein the pillar includes an arcuate end portion extending out of the second stem.

4. The folding device with a safe retainer as claimed in claim 2, wherein the pillar includes an arcuate end portion extending out of the second stem.

5. The folding device with a safe retainer as claimed in claim 1, wherein the button includes a slot formed therein, and the second stem includes a third aperture radially disposed in the groove so that a second screw allows to be positioned to the indention of the pillar through the groove.

6. The folding device with a safe retainer as claimed in claim 1, wherein the button is formed in a T shape, the positioning peg includes a first aperture radially fixed therein in response to the positioning peg.

7. The folding device with a safe retainer as claimed in claim 1, wherein a connection of the elongated side of the engaging member and the positioning peg is provided with a beveled surface.

8. The folding device with a safe retainer as claimed in claim 1, wherein the second stem is fixed to the coupling segment of the adjusting shaft member.
